(19) United States
(12) Patent Application Publication
(10) Pub. No.: US 2008/0080627 A1
(43) Pub. Date: Apr. 3, 2008

(54) Controlling filter in connection with cyclic transmission format

(76) Inventors: Juha S. Korhonen, Espoo (FI); Kari Pajukoski, Oulu (FI); Esa Tiirola, Kempele (FI); Petri J. Vaisanen, Kempele (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/540,704

(22) Filed: Oct. 2, 2006

(51) Int. Cl. H04K 1/10

(52) U.S. Cl. 375/260

(57) ABSTRACT

A method for controlling a filter, a transmitter, a receiver and an apparatus are provided. The apparatus comprises a filter configured to filter signal blocks to be transmitted in a cyclic transmission form and a controller configured to select a roll-off factor of the filter for a signal block depending on whether transmission is performed in a synchronous or an asynchronous mode.

### FIELD

The invention relates to transmitting signal blocks in a cyclic transmission format.

### BACKGROUND

In many communication systems, both synchronous and asynchronous transmission modes are used. In the synchronous transmission mode, a transmitter and a receiver are synchronized with each other. In such cases, the receiver may control the transmission timing of the transmitter, for example. In the asynchronous transmission mode, there is no common clock between a transmitter and receiver. Thus, accurate timing of transmissions is not possible.

In several systems, transmission is performed block-wise. Thus, symbols to be transmitted are grouped into blocks of a given size prior to transmission. Furthermore, a cyclic transmission mode may be utilized. In a realization of a cyclic transmission mode, each block to be transmitted is made cyclic by inserting a cyclic prefix, for example a copy of the tail part of the block, to the beginning of the block. A cyclic prefix prevents inter-block interference and enables frequency domain equalization. In another realization of a cyclic transmission mode, a guard period is added, for instance, to the end of the block. The receiver can then construct a cyclic signal with an overlap-and-add technique. A receiver, such as a base station, may control the transmission timings of the different transmitters, such as user equipment, in such a manner that the signals received by the receiver are time-aligned within the cyclic prefix or a guard period. The timing control is needed as the distance between each transmitter and the receiver and thus the propagation delay may vary.

Besides synchronous transmission with timings aligned by the receiver, also asynchronous transmission without timing alignment is sometimes needed. For example, when user equipment is accessing a network for the first time, it is unaware of correct timing offset used to combat propagation delay. In addition, the timing offset of user equipment may be out of date if the user equipment has not been transmitting for a long time. An example of the asynchronous transmission is a random access burst that user equipment has to send when it is accessing a network for the first time.

In many cases, the delay uncertainty of the asynchronous transmission is very large compared with the width of the cyclic prefix that is sufficient for synchronous transmission. In such cases, it is not possible to prolong the cyclic prefix to cover also the asynchronous case but two modes are usually needed: synchronous transmission includes a short cyclic prefix, while in the asynchronous transmission mode, a guard time, corresponding to the unknown propagation delay, is used.

Transmissions on adjacent frequency bands usually interfere with each other. In many systems, transmissions of symbol blocks are filtered with a pulse shaping filter which is designed to minimize adjacent channel interference. In synchronized transmission, transmission timings of the different user equipment may be controlled in such a manner that all the significant signal components of the transmission arrive at a base station within the cyclic prefix. The interference between the user equipment that are transmitting parallel in time but at different frequencies is limited, and the pulse shaping can be optimized taking into account mainly the spectrum efficiency and the PAPR (Peak to Average Power Ratio).

However, synchronous and asynchronous transmissions set different requirements for the roll-off factor of the pulse shaping filtering that is used for isolating the user equipment for the different frequency bands. Asynchronous transmissions produce large interference to the user equipment in adjacent channels within the system bandwidth. Thus, a large roll-off would be beneficial.

If a common roll-off value to both synchronous and asynchronous transmissions is used and the roll-off is tuned for minimizing interference in the case of the asynchronous transmission, the spectrum efficiency is sacrificed. On the other hand, if the roll-off is optimized without taking into account the asynchronous transmission, performance of the synchronous transmission is varying in an unpredictable way depending on the presence of the asynchronous transmission on an adjacent frequency resource.

### BRIEF DESCRIPTION OF THE INVENTION

An object of the invention is to provide an improved solution for transmitting signal blocks in a cyclic transmission format. According to an aspect of the invention, there is provided a method, comprising: transmitting signal blocks in a cyclic transmission format; selecting a roll-off factor of a signal block depending on whether transmission is performed in a synchronous or an asynchronous mode.

According to another aspect of the invention, there is provided a transmitter, comprising: a filter configured to filter signal blocks to be transmitted in a cyclic transmission format; a controller configured to select a roll-off factor of the filter for a signal block depending on whether the transmitter is in a synchronous or an asynchronous mode.

According to another aspect of the invention, there is provided an apparatus, comprising: a filter configured to filter signal blocks to be transmitted in a cyclic transmission format; a controller configured to select a roll-off factor of the filter for a signal block depending on whether transmission is performed in a synchronous or an asynchronous mode.

According to another aspect of the invention, there is provided an apparatus, comprising: means for filtering signal blocks to be transmitted in a cyclic transmission format; means for selecting a roll-off factor of the filter for a signal block depending on whether transmission is performed in a synchronous or an asynchronous mode.

According to another aspect of the invention, there is provided an apparatus in a receiver, comprising: a filter configured to filter received cyclic transmission format signal blocks; a controller configured to select a roll-off factor of the filter for a signal block depending on whether the receiver is in a synchronous or an asynchronous mode.

According to yet another aspect of the invention, there is provided a computer program distribution medium readable by a computer and encoding a computer program of instructions for executing a computer process for transmitting signal blocks in a cyclic transmission format and selecting a roll-off factor of a signal block depending on whether transmission is performed in a synchronous or a asynchronous mode.

### LIST OF DRAWINGS

In the following, the invention will be described in greater detail with reference to the embodiments and the accompanying drawings, in which

FIG. 1 shows an example of a data transmission system in which embodiments of the invention may be applied;

FIG. 2 illustrates an example of the division of uplink radio resources,

FIG. 3 illustrates synchronous and asynchronous transmissions,

FIG. 4 illustrates a frequency response of a root raised cosine filter,

FIG. 5 is a flowchart illustrating an embodiment of the invention,

FIGS. 6A, 6B and 6C illustrate examples of a transmitter of an embodiment of the invention,

FIG. 7 is a flowchart illustrating an embodiment of the invention,

FIG. 8 illustrates frequency allocation of a simulation,

FIG. 9 shows block error rate as a function of the signal to noise ratio in the presence of asynchronous transmission on the adjacent frequency allocation, and

FIG. 10 illustrates a receiver of an embodiment of the invention.

### DESCRIPTION OF EMBODIMENTS

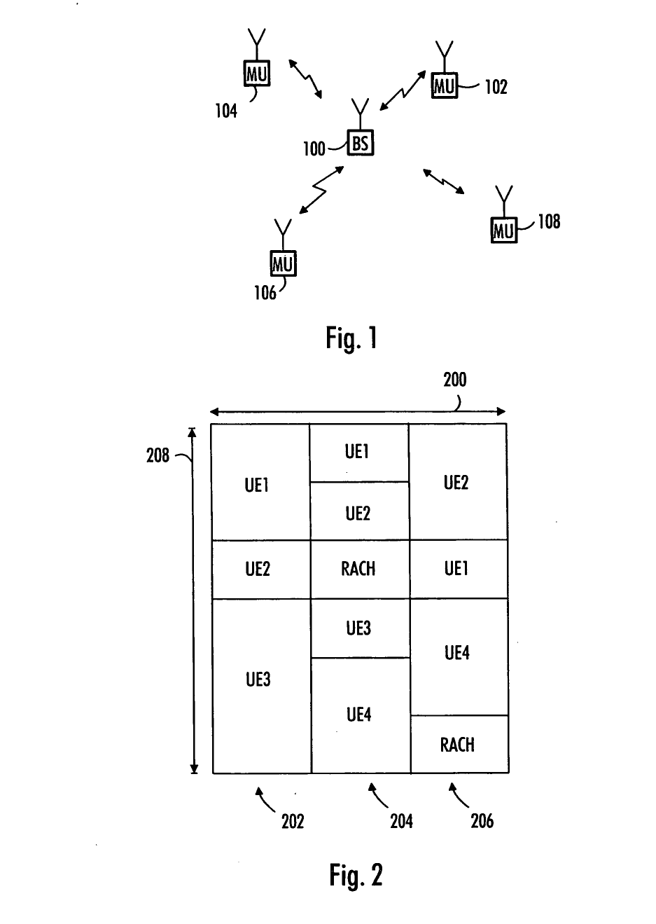

With reference to FIG. 1, examine an example of a data transmission system in which embodiments of the invention may be applied. The present invention is applicable in various telecommunication systems where different multiple access methods may be used. A typical example of a system in which the invention may be applied is the evolution of the third generation system utilizing EUTRA (Enhanced Universal Terrestrial Radio Access) as a radio access network. EUTRA is currently being developed. However, the embodiments of the invention are not limited to EUTRA.

FIG. 1 shows a base station 100 and a group of mobile units 102, 104, 106 and 108. In this example, the mobile units 102-108 communicate in uplink direction with the base station 100 using SC-FDMA (Single Carrier Frequency Division Multiple Access) multiple access scheme. In this example, uplink radio resources are divided in time sub-frames and frequency blocks. These resource units of frequency and time are allocated for the different mobile units in such a manner that several mobile units may transmit simultaneously but using different frequency resources within the system bandwidth. In addition to the scheduled resources, a part of the resources are reserved for random access. Mobile units are allowed to transmit on RACH (Random Access Channel) without being scheduled.

The mobile units in FIG. 1 may be mobile, stationary or fixed user equipment, as one skilled in the art is aware.

FIG. 2 illustrates an example of uplink radio resources. In the figure, the horizontal axis denotes time and the vertical axis denotes frequency. The figure shows a time frame 200 divided into three transmission time intervals (TTI) 202, 204, 206. The available frequency band 208 may be divided into frequency blocks or resource units of different sizes within each transmission time interval. Some of the resource units are allocated for different mobile units and some are left unallocated for random access purposes. For example, three resource units have been allocated for mobile unit 102 and two resource units have been allocated for mobile unit 106. The unallocated resource units are marked with RACH in FIG. 2.

The transmissions on allocated resource blocks are synchronous. The transmissions are made block-wise, and each transmitted block is made cyclic by inserting a cyclic prefix or a copy of the tail part of the block, to the beginning of the block. A cyclic prefix prevents inter-block interference and enables frequency domain equalization in the receiver. The base station controls the transmission timings of the different mobile units in such a manner that the received signals are time-aligned within the cyclic prefix.

Transmissions utilizing in the unallocated resource units are asynchronous. For example, a mobile unit may transmit a random access burst to the base station in an unallocated resource unit when it is accessing the network for the first time. A guard time may be added to the random access burst.

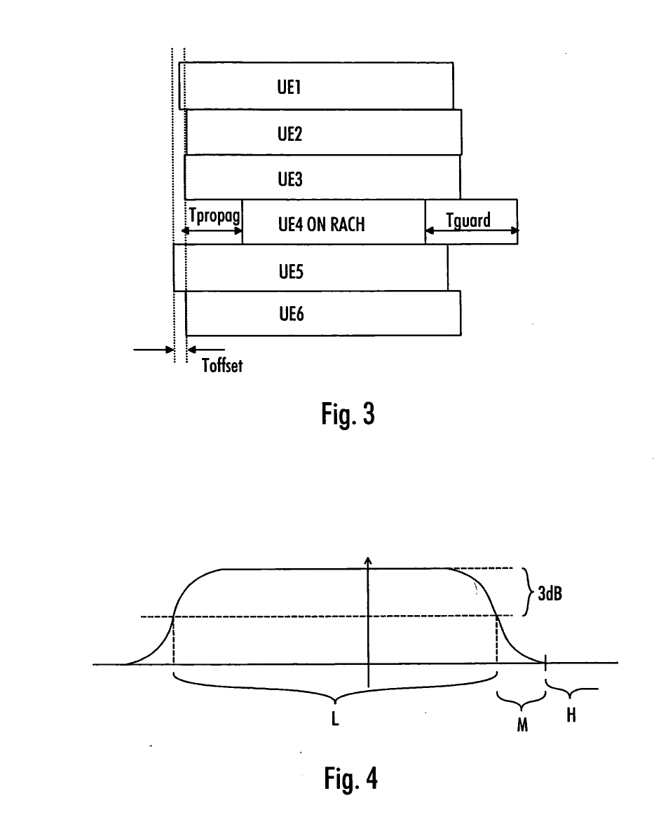

FIG. 3 illustrates synchronous and asynchronous transmissions as seen by a base station. In FIG. 3, mobile units UE 1, UE2, UE3, UE5 and UE6 are transmitting synchronously to the base station. The base station has controlled the timing of the transmissions of the mobile units in such a manner that the transmissions arrive at the base station within a timing offset T_{offset}. The timing control compensates the signal propagation delay which depends on the distance of each mobile unit from the base station. T_{offset} is the allowed timing difference and it is smaller than the length of the cyclic prefix.

The mobile unit UE 4 is transmitting asynchronously on RACH and the timing of the transmission has not been adjusted for compensating the signal propagation delay. The RACH burst is defined to be shorter than allocation on the scheduled and synchronized channels in order to prevent leakage of signal to the next time slot. A guard time T_{guard} is selected according to the maximum value of the propagation delay T_{propag}. These may be preselected system variables.

In many systems, symbol blocks to be transmitted are filtered with a pulse shaping filter prior to the transmission. The pulse shaping filter is designed to minimize adjacent channel interference.

FIG. 4 illustrates a frequency response of a root raised cosine filter. A root raised cosine filter is used here as an example of a typical pulse shaping filter. However, embodiments of the invention may be applied to other types of filters in a similar manner.

In an ideal situation, the frequency response consists of unity gain at low frequencies L, the square root of the raised cosine function in the middle M, and total attenuation at high frequencies H. The low frequency area L is determined as the area within which the attenuation of the signal is smaller than 3 dB. The width of the middle frequency areas at both ends of the response is defined by the roll-off factor constant, which can be defined as the relation of the low frequency areas to the middle frequency area, or RF=2M/L. The roll-off factor is always between 0 and 1.

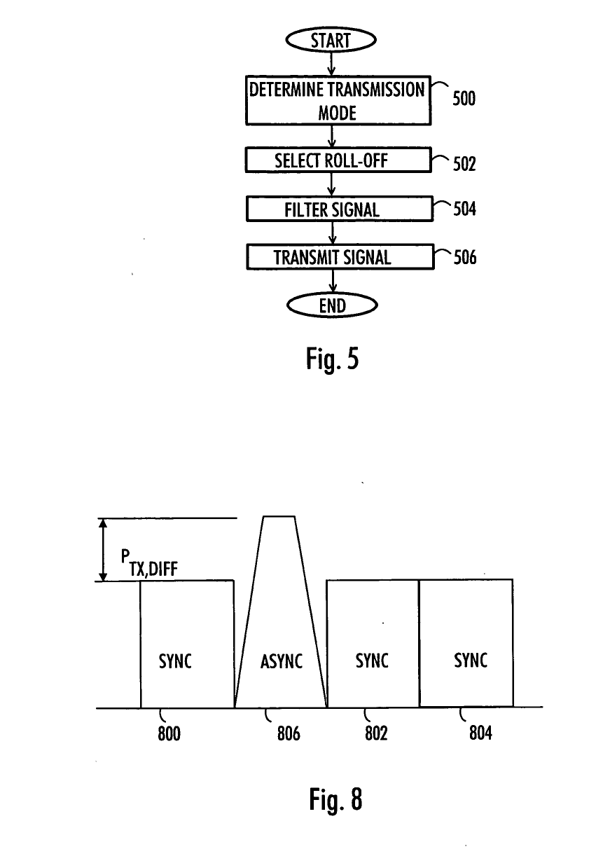

Thus, a transmitter may be in at least two different modes: synchronous and asynchronous. FIG. 5 is a flowchart illustrating an embodiment of the invention. In step 500, a transmitter determines the current transmission mode: synchronous or asynchronous mode.

In step 502, the transmitter selects the roll-off factor for a pulse shaping filter on the basis of the transmission mode. For example, in the synchronous mode the roll-off may be 0, whereas in the asynchronous mode the roll-off may have a value of 0.9. These numerical values have been presented for illustrative purposes only. In practice, the roll-off factor may have many different values.

In step 504, the transmitter filters the signal to be transmitted using a pulse shaping filter with a selected roll-off factor.

In step 506, the filtered signal is transmitted.

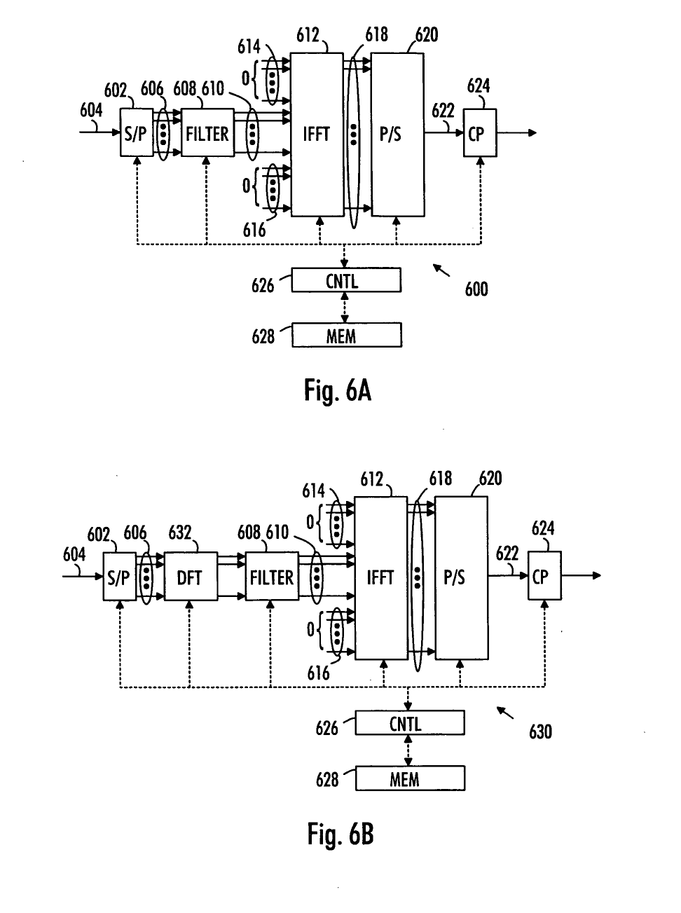

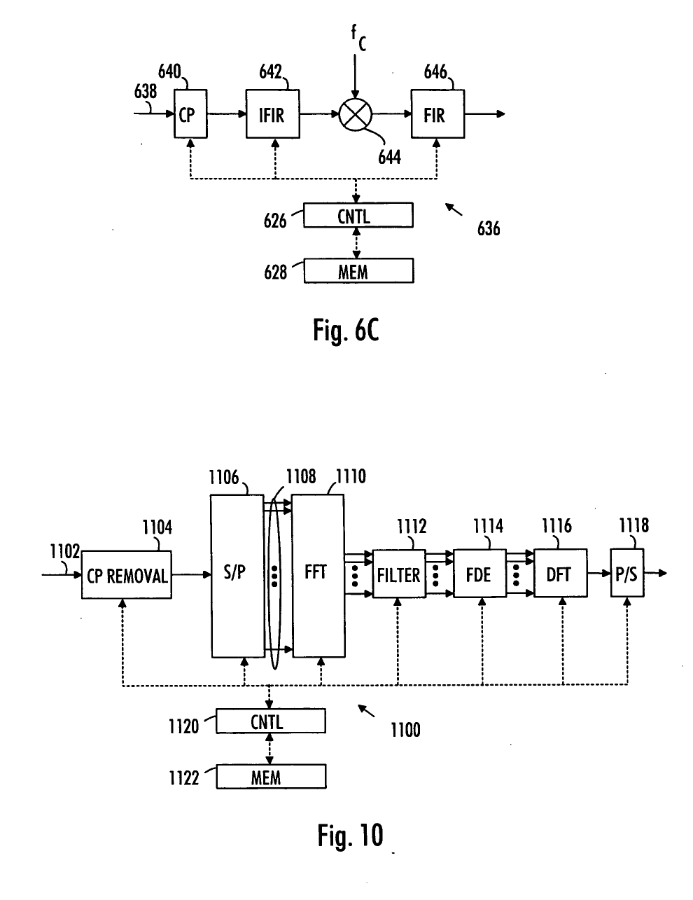

FIG. 6A illustrates an example of a transmitter of an embodiment of the invention. The transmitter of FIG. 6 is utilizing OFDM. The figure shows the partial structure of the transmitter 600. The transmitter comprises also other components, such as a radio frequency unit and an antenna, for example. These are not shown for the sake of clarity.

The transmitter comprises a first transformer 602 receiving as an input, symbols 604 of a signal block to be transmitted in a serial format. The transformer performs serial to parallel transform and provides as an output the input symbols in a parallel format 606. The symbols are applied to a pulse shaping filter 608. The filter may be a root cosine or a raised root cosine filter, for example. Also other waveforms may be used in the filter. The filter has a given roll-off factor illustrated in FIG. 4. The filtered signal 610 is applied to a second transformer 612 performing an inverse fast Fourier transform to the signal. The other input 614 and 616 have zero values. The transformer 612 transforms the signal to desired frequencies in the available frequency band.

The output 618 of the transformer 612 is applied to a third transformer 620 configured to convert the parallel format signal 618 at the output of the second transformer into a serial form signal 622. A windowing unit 624 adds a cyclic prefix to the signal and performs time domain smoothing of the signal (windowing). The cyclic prefix may be omitted if the transmitter is transmitting in asynchronous mode. From the windowing unit the signal is applied to radio frequency parts of the transmitter (not shown).

The transmitter further comprises at least one controller 626. The controller 626 may have an associated memory 628. The controller 626 controls the operation of the transmitter.

The controller 626 is aware of the mode of the transmitter. Thus, it is aware whether the transmitter is transmitting in synchronous or asynchronous mode.

The pulse shaping filter 608 is controlled by the controller 626. The roll-off factor of the filter is adjustable. The roll-off of the filter 608 may comprise at least two different values, one for synchronous transmission mode and another for asynchronous transmission mode. The controller is configured to control the filter to select thee desired roll-off factor on the basis of the transmission mode of the transmitter.

The controller 626 may be realized with a signal processing or general processor and associated software which may be stored in the memory 628. The controller may be realized with discrete logic circuits or ASIC (Application Specific Integrated Circuit). Also other parts of the transmitter shown in FIG. 6A may be realized using signal processing units. The units may be realized using one or more integrated circuits.

FIG. 6B illustrates another example of a transmitter of an embodiment of the invention. The transmitter of FIG. 6 is utilizing DFT-S-OFDM. The figure shows a partial structure of the transmitter 630. The transmitter also comprises other components, such as a radio frequency unit and an antenna, for example. These are not shown for the sake of clarity.

The structure of the transmitter 630 is otherwise similar to the structure of the transmitter 600 presented in FIG. 6A, but it comprises a fourth transformer 632 configured to perform a discrete Fourier transform (DFT) to the symbols at the output of the first transformer 602. The output of the fourth transformer 632 is connected to the input of the pulse shaping filter 608.

FIG. 6C illustrates another example of a transmitter of an embodiment of the invention. The transmitter 636 of FIG. 6C is utilizing CP/SC-FDMA (Cyclic Prefix Single Carrier Frequency Division Multiple Access). The symbols 638 to be transmitted are applied to a processing unit 640 which adds a cyclic prefix to symbol blocks. From the processing unit 640 the symbols are applied to an IFIR (Interpolating Finite Impulse Response) filter 642 which is a pulse shaping filter. The filtered signal is shifted in frequency by multiplying it by a carrier frequency f_{c} in a multiplier 644. The shifted signal may be filtered by a FIR filter 646 where the spectrum of the signal is shaped. Finally, the signal is applied into radio frequency parts of the transmitter (not shown).

The pulse shaping filter 642 is controlled by the controller 626. The roll-off factor of the filter is adjustable. The roll-off of the filter 642 may comprise at least two different values, one for synchronous transmission mode and another for asynchronous transmission mode. The controller is configured to control the filter to select the desired roll-off factor on the basis of the transmission mode of the transmitter.

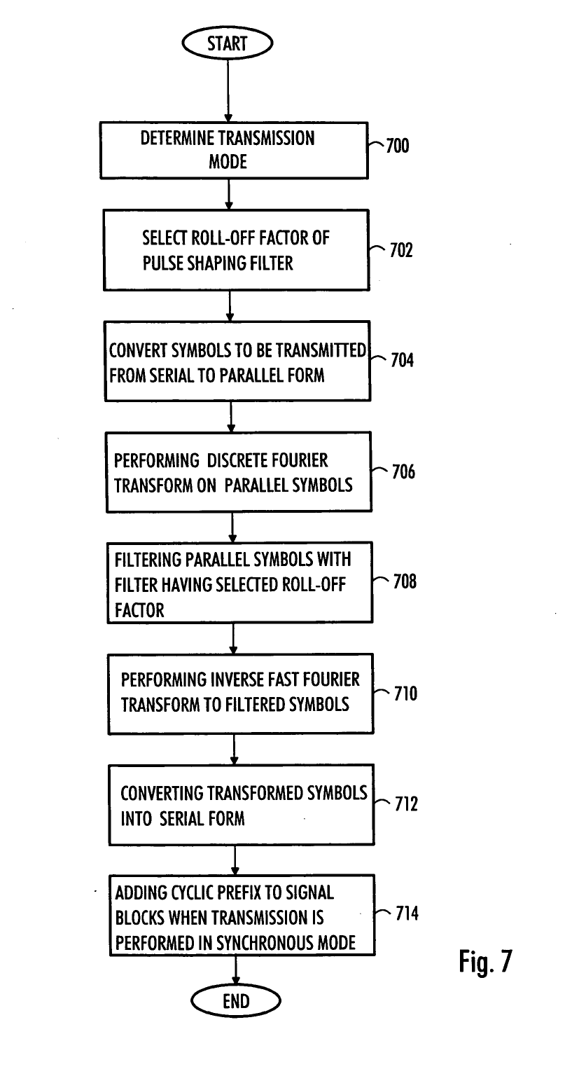

FIG. 7 is a flowchart illustrating an embodiment of the invention. The illustrated embodiment corresponds to the transmitter structure of FIG. 6B.

In step 700, the controller 626 determines the current transmission mode: synchronous or asynchronous mode.

In step 702, the controller 626 selects the desired roll-off factor for the filter 608 on the basis of the transmission mode.

In step 704, symbols to be transmitted are transformed from a serial to a parallel form in transformer 602.

In step 706, a discrete Fourier transform is performed on the parallel symbols in transformer 632.

In step 708, the parallel symbols are filtered with the filter 608 having the selected roll-off factor.

In step 710, an inverse fast Fourier transform is performed on filtered symbols in transformer 612.

In step 712, the transformed symbols are converted into a serial form in transformer 620.

In step 714, a cyclic prefix is added to signal blocks in the widowing unit when transmission is performed in synchronous mode. When transmission is performed in asynchronous mode, the cyclic prefix is not necessarily used.

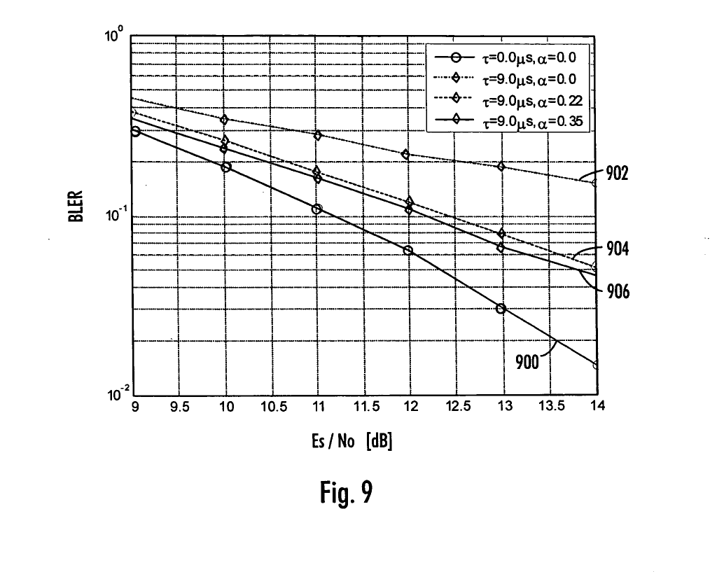

The degradation due to the asynchronous transmission and the performance of proposed embodiments have been studied with simulations using frequency allocation shown in FIG. 8. Three mobile units are transmitting in a synchronous mode in bands 800, 802, 804. One asynchronously transmitting mobile unit is transmitting in band 806. The performance of the mobile units transmitting adjacent to the asynchronous transmission was recorded with different roll-offs applied in the asynchronously transmitting mobile unit. An example of the results, shown in FIG. 9, demonstrates how the interference caused by the mobile unit transmitting asynchronously can be lowered by controlling the roll-off in the asynchronous transmission.

The simulations were made using following parameters. The system bandwidth was assumed to be 5 MHz. The effective bandwidth of the synchronized mobile units was 1.125 MHz and the roll-off factor α of the pulse shaping filter was selected as α=0.

The effective bandwidth of the asynchronous mobile unit was (1−α) 1.125 MHz. The power difference P_{TX,DIFF} of the total transmission power of the asynchronous mobile unit and the power of the synchronously transmitting mobile units was 6 dB. The powers were adjusted this way independently of the roll-off, meaning that the peak power density was increasing with the roll-off.

The time windowing was made by smoothing the beginning and the end of the blocks with raised cosine shape within the width of 0.78 ms. 16QAM modulation with ⅔ coding was used. Two-antenna reception, LMMSE receiver with frequency domain equalization, TU channel model and ideal channel estimation were assumed.

FIG. 9 shows a block error rate (BLER) as a function of the signal to noise ratio in the presence of asynchronous transmission on the adjacent frequency allocation. The lowest curve 900 is the performance when all transmission timings are ideally adjusted. Thus, the timing offset τ is zero. The other curves 902, 904, and 906 are obtained when there is a timing offset of 9 microsec between the transmissions and the length of the cyclic prefix is assumed to be 4 microsec. In curve 902, the roll-off factor α used by the asynchronously transmitting mobile unit is 0. In curve 904, the roll-off factor α used by the asynchronously transmitting mobile unit is increased to 0.22. In curve 906, the roll-off factor α used by the asynchronously transmitting mobile unit is further increased to 0.35. In all curves, the roll-off factor used by the synchronously transmitting mobile units was 0.

As FIG. 9 shows, an increase in the roll-off factor used by the asynchronously transmitting mobile unit reduces the interference experienced by the mobile units transmitting synchronously in the adjacent bands.

In an embodiment, the pulse shaping filtering operation is divided between the transmitter and the receiver. Thus, the roll-off factor adjustment may be performed both in the transmitter and the receiver. For example, a base station receiving a signal block transmitted using a cyclic transmission format may be controlled to use a given roll-off factor when receiving and filtering synchronous transmissions and to use a different roll-off factor when monitoring frequency units reserved for asynchronous transmissions. In another embodiment, a transmitter may send information to the receiver about the roll-off factor used in the transmission. The information may be sent using control channels.

FIG. 10 illustrates a receiver utilizing DFT-S-OFDM. The receiver 1100 corresponds to the transmitter of FIG. 6B. The radio frequency part of the receiver (not shown) provides a processing unit 1104 with the received signal 1102. The processing unit is configured to remove the cyclic prefix, if any, from the signal. The signal is further applied to a first transformer 1106 which is configured to convert the signal into a parallel form. The parallel form signal 1108 is applied to a second transformer 1110 which performs IFFT (Fast Fourier Transform) to the signal. The transformed signal is applied to a pulse shaping filter 1112 configured to filter the signal using a selected roll-off factor. Next frequency domain equalization is performed on the signal in an equalizer 1114. The equalized signal is taken to a third transformer 1116 configured to perform DFT (discrete Fourier transform) to the signal. Finally, the signal is taken to a fourth transformer 1118 which is configured to convert the signal into a serial form.

The receiver 1100 further comprises at least one controller 1120. The controller 1120 may have an associated memory 1122. The controller 1120 controls the operation of the receiver.

The controller 1120 is aware of the mode of the receiver. Thus, it is aware whether the receiver is receiving in synchronous or asynchronous mode.

The pulse shaping filter 1112 is controlled by the controller 1120. The roll-off factor of the filter is adjustable. The roll-off of the filter 1112 may comprise at least two different values, one for synchronous transmission mode and another for asynchronous transmission mode. The controller is configured to control the filter to select the desired roll-off factor on the basis of the transmission mode of the receiver.

The controller 1120 controls the operation of the receiver. The controller may be realized with a signal processing or general processor and associated software which may be stored in the memory 1122. The controller may be realized with discrete logic circuits or ASIC (Application Specific Integrated Circuit).

Also other parts of the receiver shown in FIG. 11 may be realized using signal processing units. The units may be realized using one or more integrated circuits.

Embodiments of the invention may be realized in a transmitter configured to transmit signal in a cyclic transmission format and comprising a pulse shaping filter configured to filter signal blocks to be transmitted. The transmitter comprises a controller. The controller may be configured to perform at least some of the steps described in connection with the flowcharts of FIGS. 5 and 7. The embodiments may be implemented as a computer program comprising instructions for executing a computer process for transmitting signal blocks in a cyclic transmission format and selecting the roll-off factor of a signal block depending on whether transmission is performed in synchronous or asynchronous mode.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it may be modified in several ways within the scope of the appended claims.

1. A method, comprising:
transmitting signal blocks in a cyclic transmission format;
selecting a roll-off factor of a signal block depending on whether transmission is performed in a synchronous or an asynchronous mode.

2. The method of claim 1, further comprising:
adding a cyclic prefix to signal blocks when transmission is performed in the synchronous mode.

3. The method of claim 1, further comprising:
adding a guard period to signal blocks when transmission is performed in the asynchronous mode.

4. The method of claim 1, further comprising:
converting symbols to be transmitted from a serial to a parallel form,
filtering the parallel symbols with a filter having the selected roll-off factor,
performing an inverse fast Fourier transform on the filtered symbols, and
converting the transformed symbols into a serial form.

5. The method of claim 1, further comprising:
performing a discrete Fourier transform on the parallel symbols prior to filtering.

6. A transmitter, comprising:
a filter configured to filter signal blocks to be transmitted in a cyclic transmission format;
a controller configured to select a roll-off factor of the filter for a signal block depending on whether the transmitter is in a synchronous or an asynchronous mode.

7. The transmitter of claim 6, further comprising:
a circuitry configured to add a cyclic prefix to signal blocks when the transmitter is in the synchronous mode.

8. The transmitter of claim 6, further comprising:
a circuitry configured to add a guard period to signal blocks when the transmitter is in the asynchronous mode.

9. The transmitter of claim 6, further comprising:
a first transformer receiving as an input, symbols in a serial form and having, as an output, the symbols in a parallel format; the output being connected to the filter;
a second transformer performing an inverse fast Fourier transform on the symbols at the output of the filter; and
a third transformer converting parallel format symbols at the output of the second transformer into a serial form.

10. The transmitter of claim 6, further comprising:
a fourth transformer, performing a discrete Fourier transform on the symbols at the output of the first transformer, the output of the fourth transformer being connected to the input of the filter.

11. An apparatus, comprising:
a filter configured to filter signal blocks to be transmitted in a cyclic transmission format;
a controller configured to select a roll-off factor of the filter for a signal block depending on whether transmission is performed in a synchronous or an asynchronous mode.

12. The apparatus of claim 11, further comprising:
a circuitry configured to add a cyclic prefix to signal blocks when the transmitter is in the synchronous mode.

13. The apparatus of claim 11, further comprising:
a circuitry configured to add a guard period to signal blocks when the transmitter is in the asynchronous mode.

14. An apparatus, comprising:
means for filtering signal blocks to be transmitted in a cyclic transmission format;
means for selecting a roll-off factor of the filter for a signal block depending on whether transmission is performed in a synchronous or an asynchronous mode.

15. The apparatus of claim 14, further comprising:
a circuitry configured to add a guard period to signal blocks when the transmitter is in the asynchronous mode.

16. An apparatus in a receiver, comprising:
a filter configured to filter received cyclic transmission format signal blocks;
a controller configured to select a roll-off factor of the filter for a signal block depending on whether the receiver is in a synchronous or an asynchronous mode.

17. A computer program distribution medium readable by a computer and encoding a computer program of instructions for executing a computer process for transmitting signal blocks in a cyclic transmission format and selecting a roll-off factor of a signal block depending on whether transmission is performed in a synchronous or a asynchronous mode.

18. The computer program distribution medium of claim 17, the process further comprising adding a guard period to signal blocks when the transmission is performed in the asynchronous mode.

19. The computer program distribution medium of claim 17, the distribution medium including at least one of the following media: a computer readable medium, a program storage medium, a record medium, a computer readable memory, a computer readable software distribution package, a computer readable signal, a computer readable telecommunications signal, and a computer readable compressed software package.
